(19) United States
(12) Patent Application Publication
(10) Pub. No.: US 2008/0239601 A1
(43) Pub. Date: Oct. 2, 2008

(54) SEMICONDUCTOR DEVICE

(75) Inventors: Naoyuki Miyazawa, Yamanashi (JP); Makoto Kondo, Yamanashi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EUDYNA DEVICES INC., Yamanashi (JP)

(21) Appl. No.: 12/059,681

(22) Filed: Mar. 31, 2008

(30) Foreign Application Priority Data
Mar. 30, 2007 (JP) 2007-089989

(51) Int. Cl. H02H 9/00

(52) U.S. Cl. 361/56

(57) ABSTRACT

A semiconductor device includes a pad; an internal circuit; a protection FET that has a drain connected to the pad, and a source connected to a reference potential; a first resistive element that is connected between the drain of the protection FET and the internal circuit, and has a larger resistance value than the value of the series resistance between the drain of the protection FET and the pad; a capacitive element that is connected between the pad and the gate of the protection FET; and a second resistive element that is connected between the gate of the protection FET and the source of the protection FET.

### BACKGROUND OF THE INVENTION

1. Field of the Invention

The present invention generally relates to a semiconductor device, and more particularly, to a semiconductor device that has a protection FET against surges.

2. Description of the Related Art

There are cases where a protection circuit is provided to protect an internal circuit from damage when a surge such as ESD (ElectroStatic Discharge) is applied to a pad of a semiconductor device. FIG. 1 is a circuit diagram of a protection circuit 10a disclosed in Japanese Unexamined Patent Publication No. 58-147068. The protection circuit 10a includes a protection FET 30, resistances Ra, Rb, and Rc, and a capacitance Ca. The resistances Ra and Rb are connected in series between a pad 14 and an internal circuit 20. The source and drain of the protection FET 30 are connected to the ground and the internal circuit 20, respectively. The protection FET 30 is an E(enhancement)-mode, n-type FET. The capacitance Ca is connected between the node between the resistance Ra and the resistance Rb, and the gate of the protection FET 30. The resistance Rc is connected between the gate and source of the protection FET 30.

In this protection circuit 10a, a surge of a positive voltage applied to the pad 14 is delayed and is applied to the gate of the protection FET 30 by a time constant circuit formed with the resistance Ra and the capacitance Ca (as indicated by the arrow A in FIG. 1). The protection FET 30 is turned on accordingly, and the surge current to flow from the pad 14 to the internal circuit 20 is directed toward the ground (as indicated by the arrow B in FIG. 1). When there is not a surge voltage applied, the resistance Rc applies the source potential to the gate of the protection FET 30 as the source potential, and turns off the protection FET 30. The resistance Rc is sufficiently larger than the impedance of the time constant circuit formed with the resistance Ra and the capacitance Ca when a surge is applied. Accordingly, when a surge of a positive voltage is applied to the pad 14 in this structure, a positive voltage is applied to the gate of the protection FET 30.

In a case where the protection circuit 10a shown in FIG. 1 is used, the ON resistance of the protection FET 30 is approximately 10Ω. To form a time constant circuit with the resistance Ra and the capacitance Ca, the resistance Ra should be approximately 1 kΩ to 2 kΩ or greater. The resistance Rb should also be approximately 1 kΩ to 2 kΩ or greater, so as to drop the surge current. Accordingly, when a surge voltage is applied to the pad 14, a large potential difference is added to the resistance Ra and the resistance Rb. The damage tolerance of the resistance Ra and the resistance Rb vary depending on the structure of each resistive element and the manufacturing method. However, in a case where sufficient damage tolerance cannot be allowed or where the damage tolerance becomes smaller due to product variations, the resistive elements might be damaged due to application of a surge voltage. If the resistive elements are damaged, the resistive elements are put into a cut-off state or a short-circuited state. As a result, the protection circuit stops functioning.

FIGS. 2A and 2B are schematic views of the resistance Ra damaged by application of a surge voltage. In FIG. 2A, the resistance Ra is formed with a semiconductor activation region 78 functioning as a resistive element, and a pad-side electrode 74 and an internal-circuit-side electrode 72 that are electrically connected to the semiconductor activation region 78. A wiring line 76 of a ground potential is formed in the vicinity of the resistance Ra. Since a surge voltage is applied to the pad-side electrode 74, a current path 80 extending from the electrode 74 to the wiring line 76 is formed.

In FIG. 2B, since a surge voltage is applied, a current path 82 between the pad-side electrode 74 and the internal-circuit-side electrode 72 is formed within the semiconductor activation region 78. As can be seen from FIGS. 2A and 2B, the protection circuit 10a disclosed in Japanese Unexamined Patent Publication No. 58-147068 is damaged by application of a surge to the pad 14.

### SUMMARY OF THE INVENTION

It is therefore an object of the present invention to provide a semiconductor device in which the above disadvantage is eliminated.

A more specific object of the present invention is to provide a semiconductor device that has a protection circuit that cannot be easily damaged and maintains high reliability even when a surge is input to the pad.

According to an aspect of the present invention, there is provided A semiconductor device including: a pad; an internal circuit; a protection FET that has a drain connected to the pad, and a source connected to a reference potential; a first resistive element that is connected between the drain of the protection FET and the internal circuit, and has a larger resistance value than a value of a series resistance between the drain of the protection FET and the pad; a capacitive element that is connected between the pad and a gate of the protection FET; and a second resistive element that is connected between the gate of the protection

### BRIEF DESCRIPTION OF THE DRAWINGS

Other objects, features and advantages of the present invention will become more apparent from the following detailed description when read in conjunction with the accompanying drawings, in which:

FIG. 1 is a circuit diagram of a conventional protection circuit;

FIGS. 2A and 2B are schematic plan views of damaged resistive elements;

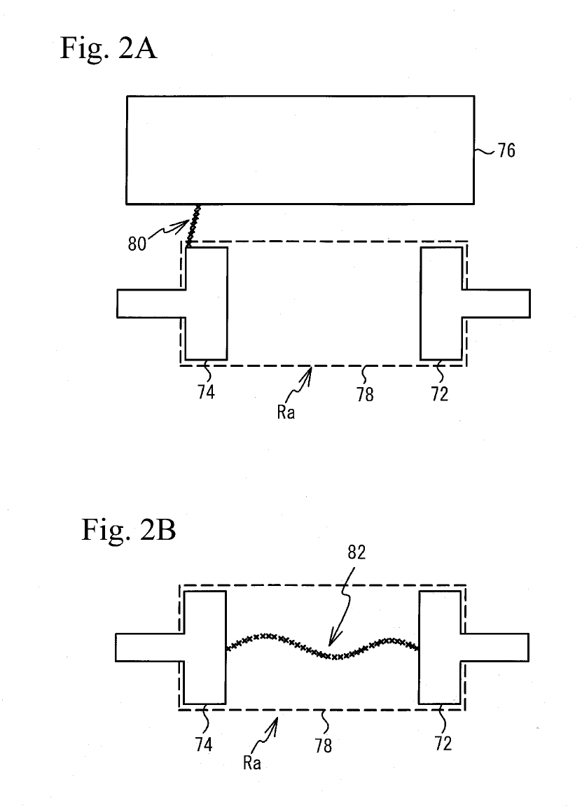

FIG. 3 is a circuit diagram of a protection circuit in accordance with a first embodiment of the present invention;

FIG. 4 is a plan view of the protection circuit in accordance with the first embodiment;

FIG. 5 is a circuit diagram of a protection circuit in accordance with a second embodiment;

FIG. 6 is a circuit diagram of a protection circuit in accordance with a third embodiment;

FIG. 7 is a circuit diagram of a protection circuit in accordance with a fourth embodiment;

FIG. 8 is a circuit diagram of a protection circuit in accordance with a fifth embodiment; and

FIG. 9 is a circuit diagram of a protection circuit in accordance with a sixth embodiment.

### DESCRIPTION OF THE PREFERRED EMBODIMENTS

The following is a description of embodiments of the present invention.

### First Embodiment

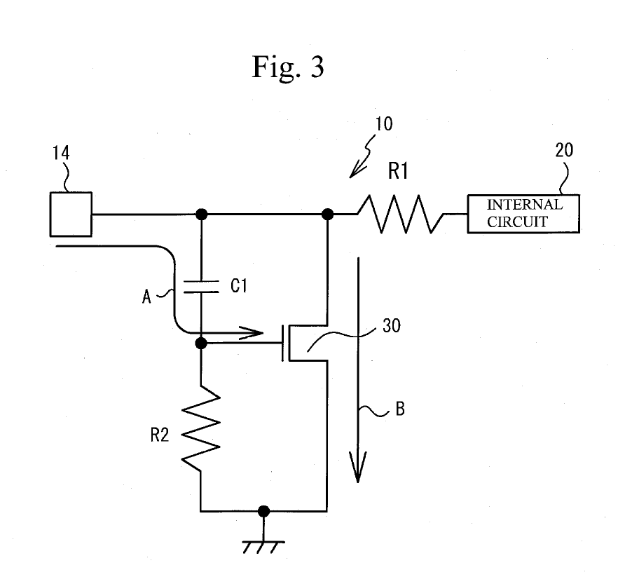

Referring to FIG. 3, a semiconductor device that includes a protection circuit 10 in accordance with a first embodiment of the present invention is described. The protection circuit 10 includes a protection FET 30, a first resistive element R1, a second resistive element R2, and a capacitive element C1. The first resistive element R1 is connected in series between a pad 14 and an internal circuit 20. The drain of the protection FET 30 is connected directly to the pad 14, and the source of the protection FET 30 is connected to the ground (reference potential). The first resistive element R1 is connected between the drain of the protection FET 30 and the internal circuit 20. The capacitive element C1 is connected between the pad 14 and the gate of the protection FET 30. The second resistive element R2 is connected between the gate and source of the protection FET 30.

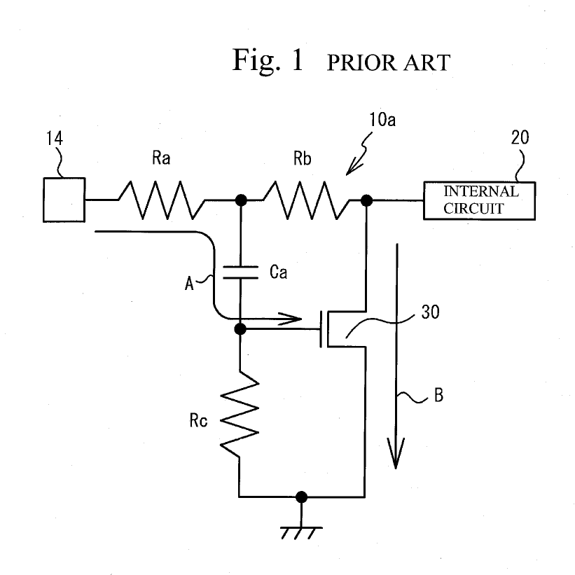

The protection FET 30 is an E-mode, n-type FET, as in the structure shown in FIG. 1. The values of the first resistive element R1, the second resistive element R2, and the capacitive element C1 may be 5 kΩ, 10 kΩ, and 1 pF, respectively. The internal circuit 20 is a radio-frequency circuit including a FET, such as a RF (radio frequency) switch, a RF amplifier, or a RF mixer, or a digital circuit. The internal circuit 20 is a circuit that is easily damaged by a surge input through the pad 14, but has characteristics that cannot be easily degraded, by virtue of the insertion of the first resistive element R1. The pad 14 to which the protection circuit 10 is attached is a pad for connecting the internal circuit 20 to the outside, such as an input pad, an output pad, or an input/output pad. The pad 14 is also a pad that easily has a surge applied thereto and causes damage to the internal circuit 20 due to the surge application.

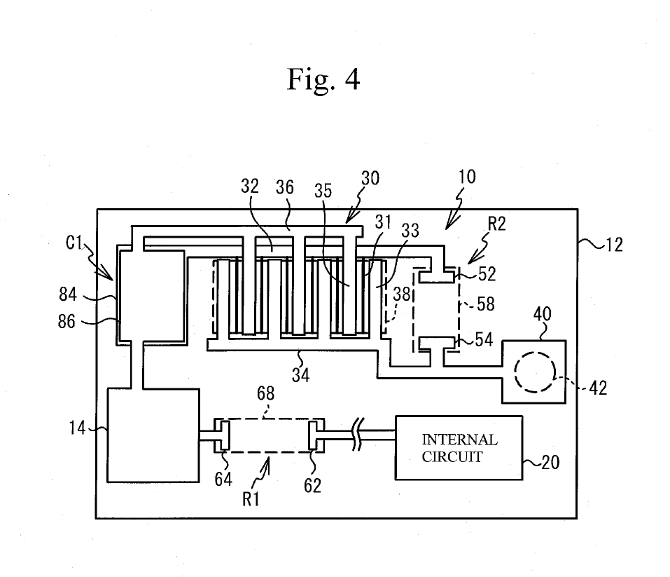

FIG. 4 is a plan view of the protection circuit 10 of the first embodiment formed on a semiconductor substrate 12 and the parts surrounding the protection circuit 10. The protection circuit 10 and the internal circuit 20 are formed on the semiconductor substrate 12. The semiconductor substrate 12 may be a Si (silicon) substrate, or a compound semiconductor substrate such as a GaAs (gallium arsenide) substrate. The protection FET 30 has gate fingers 31, source fingers 33, and drain fingers 35 that are provided on an activation region 38 of the semiconductor substrate 12 (or a semiconductor layer). The gate fingers 31 are connected to a gate bus bar 32. The source fingers 33 and the drain fingers 35 are connected to a source bus bar 34 and a drain bus bar 36, respectively. The first resistive element R1 is formed with a semiconductor activation region 58 functioning as a resistive element, and electrodes 52 and 54 electrically connected to the semiconductor activation region 58. The second resistive element R2 is formed with a semiconductor activation region 68, and electrodes 62 and 64 electrically connected to the semiconductor activation region 68. The capacitive element C1 is a MIM (Metal Insulator Metal) capacitor that is formed with a lower electrode 84, an upper electrode 86, and a dielectric layer (not shown).

The source bus bar 34 and the electrode 54 are connected to the ground on the back face of the semiconductor substrate 12 through a via hole 42 formed in a via pad 40. The connection to the ground may involve a wiring line formed on the front face of the semiconductor substrate 12. The gate bus bar 32 is connected to the electrode 52 and the lower electrode 84. The drain bus bar 36 is connected to the upper electrode 86. The pad 14 is connected to the upper electrode 86 and the electrode 64. The electrode 62 is connected to the internal circuit 20. In this manner, the pattern shown in FIG. 4 forms the circuit shown in FIG. 3.

In accordance with the first embodiment, the first resistive element R1 for reducing the surge current is provided closer to the internal circuit 20 than to the drain of the protection FET 30. The drain of the protection FET 30 is connected directly to the pad 14, not involving a resistive element. With this arrangement, a surge voltage applied to the pad 14 is applied to the gate protection FET 30 via the capacitive element C1 (as indicated by the arrow A in FIG. 3). Accordingly, the protection FET 30 is turned on. The ON resistance of the protection FET 30 may be 10Ω, for example. The ON resistance is reasonably smaller than the first resistive element R1, and the surge current flows from the pad 14 to the ground, accordingly (as indicated by the arrow B in FIG. 3). As in the structure shown in FIG. 1, the second resistive element R2 applies the source potential to the gate of the protection FET 30, and puts the protection FET 30 into an OFF state. Although the source of the protection FET 30 is connected to the ground in the first embodiment, the source of the protection FET 30 should be connected at least to the reference potential for releasing the surge current.

In the conventional example shown in FIG. 1 and the first embodiment shown in FIG. 3, a test was carried out to examine the damage caused by ESD, with the use of the human body model. The results of the test are shown in Table 1. While the ESD breakdown voltage in the conventional example was approximately 100 V, the ESD breakdown voltage in the first embodiment was approximately 1000 V. As can be seen from the results, the first embodiment can have tolerance for damage ten times greater than that of the conventional example.

TABLE 1

| | Conventional Example | First Embodiment |
|---|---|---|
| ESD | about 100 V | about 1000 V |
| Breakdown | | |
| voltage | | |

### Second Embodiment

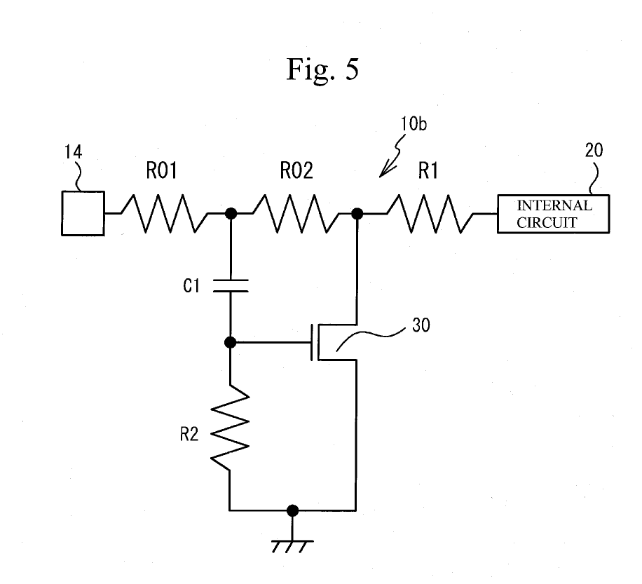

Referring now to FIG. 5, a protection circuit 10b in accordance with a second embodiment of the present invention is described. The structure of the second embodiment differs from the structure of the first embodiment shown in FIG. 3 in that resistances R01 and R02 are connected between the pad 14 and the drain of the protection FET 30. The resistances R01 and R02 may be resistive elements or wiring resistances, for example. The other aspects of this structure are the same as those of the structure of the first embodiment shown in FIG. 3, and therefore, explanation of them is omitted here.

If the resistance values of the resistances R01 and R02 are large in the structure shown in FIG. 5, the resistances R01 and R02 are damaged due to a surge, as in the protection circuit 10a shown in FIG. 1. In a case where the sum of the resistance values of the resistances R01 and R02 (the series resistance value between the drain of the protection FET 30 and the pad 14) is equal to or larger than the resistance value of the first resistive element R1, the existence of the first resistive element R1 connected between the drain of the protection FET 30 and the internal circuit 20 is becomes meaningless. Therefore, the resistance value of the first resistive element R1 should preferably be larger than the series resistance value between the drain of the protection FET 30 and the pad 14.

To protect the resistances R01 and R02 from damage, the sum of the resistance values of the resistances R01 and R02 should preferably be equal to or smaller than the value ten times larger than the value of the ON resistance of the protection FET 30. Further, in a case where the sum of the resistance values of the resistances R01 and R02 is equal to or smaller than the value of the ON resistance of the protection FET 30, only a potential difference that is equal to or smaller than that of the protection FET 30 is added to the resistances R01 and R02. Accordingly, the possibility that the resistance R01 or the resistance R02 is damaged becomes almost zero. Particularly, in a case where the resistances R01 and R02 involve the semiconductor activation region, the maximum current of the resistances R01 and R02 is almost the same as that of the protection FET 30. Accordingly, in a case where only a potential difference equal to or smaller than that of the protection FET 30 is added to the resistances R01 and R02, damage to the resistances R01 and R02 can be prevented.

### Third Embodiment

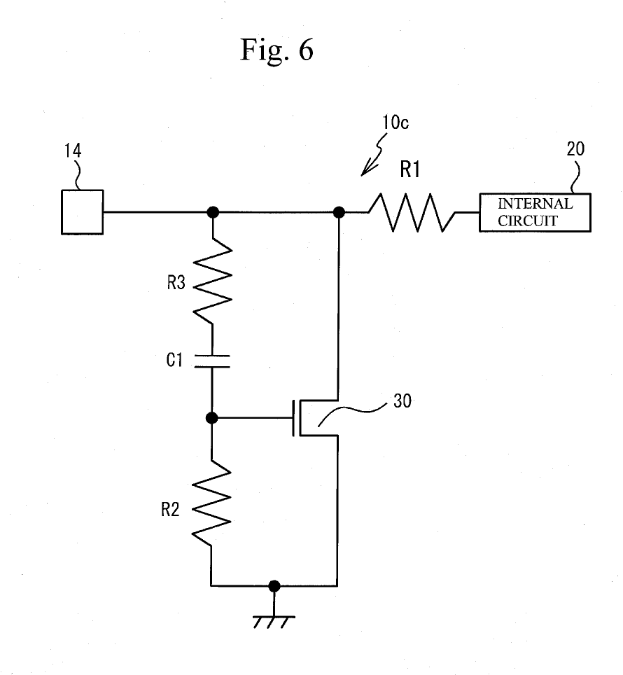

Referring now to FIG. 6, a protection circuit 10c in accordance with a third embodiment of the present invention is described. The structure of the third embodiment differs from the structure of the first embodiment shown in FIG. 3 in that a third resistive element R3 is connected between the capacitive element C1 and the pad 14. The resistance value of the third resistive element R3 may be 1 kΩ, for example. The other aspects of this structure are the same as those of the structure of the first embodiment shown in FIG. 3, and therefore, explanation of them is omitted here.

In a case where ESD is caused by various electronic devices called the “machine model”, a surge voltage is applied in a very short period of time. If this happens in the structure of the first embodiment, the capacitive element C1 might be damaged by a rapid potential increase. Particularly, in a case where the capacitive element C1 is a MIM capacitor manufactured by a semiconductor manufacturing process, the tolerance for damage due to a surge voltage is small, and damage might be caused.

In accordance with the third embodiment, the third resistive element R3 can slow down the rapid increase of the voltage applied to the capacitive element C1. Accordingly, damage to the capacitive element C1 can be prevented. Also, the third resistive element R3 and the capacitive element C1 may have the same functions as the time constant circuit formed with the resistance Ra and the capacitance Ca in the structure shown in FIG. 1.

### Fourth Embodiment

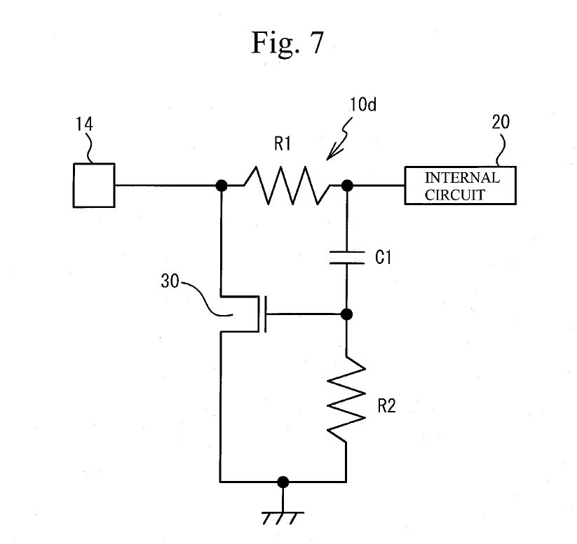

Referring now to FIG. 7, a protection circuit 10d in accordance with a fourth embodiment is described. In the first embodiment, the capacitive element C1 is connected between the nodes between the first resistive element R1 and the pad 14, and the gate of the protection FET 30, as shown in FIG. 3. In the fourth embodiment, on the other hand, the capacitive element C1 is connected between the node between the first resistive element R1 and the internal circuit 20, and the gate of the protection FET 30. The other aspects of this structure are the same as those of the structure of the first embodiment shown in FIG. 3, and therefore, explanation of them is omitted here.

In accordance with the fourth embodiment, the first resistive element R1 reduces the surge current to the internal circuit 20, and prevents damage to the capacitive element C1 (the same function as that of the third resistive element R3 of the third embodiment shown in FIG. 6). Accordingly, the number of resistive elements can be made smaller than that in the first embodiment.

In the third and fourth embodiments, a smaller series resistance than the resistance value of the first resistive element R1 may be connected between the drain of the protection FET 30 and the pad 14, as in the second embodiment.

### Fifth Embodiment

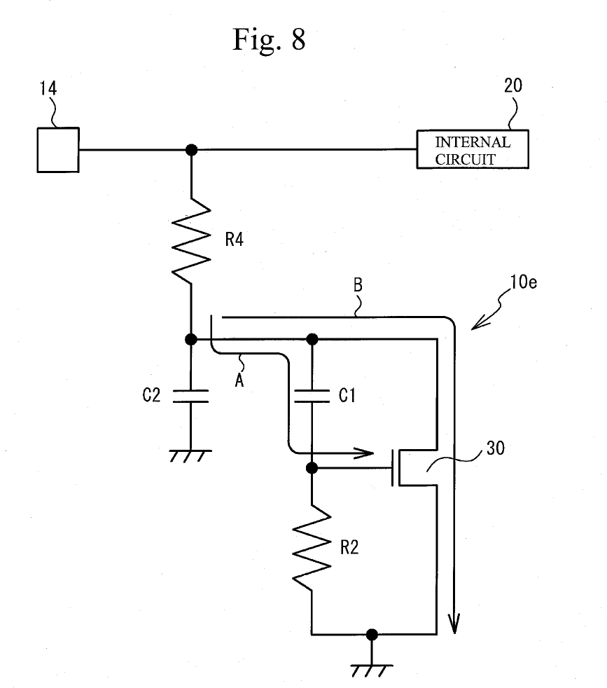

Referring now to FIG. 8, a fifth embodiment is described. As shown in FIG. 8, one end of a fourth resistive element R4 is connected to a node between the pad 14 and the internal circuit 20. The other end of the fourth resistive element R4 is connected to the ground via a capacitive element C2. A protection circuit 10e is connected to the other end of the fourth resistive element R4. The protection circuit 10e includes the protection FET 30, the capacitive element C1, and the second resistive element R2. The drain of the protection FET 30 is connected to the other end of the fourth resistive element R4, and the source of the protection FET 30 is connected to the ground (the reference potential). Further, the capacitive element C1 is connected between the other end of the fourth resistive element R4 and the gate of the protection FET 30. The second resistive element R2 is connected between the gate and source of the protection FET 30.

In the fifth embodiment, the resistive element R4 is not connected between the pad 14 and the internal circuit 20, which differs from the first embodiment. Accordingly, in a case where the pad 14 is an input/output terminal for RF signals, and the series resistance between the pad 14 and the internal circuit 20 has influence on performance, the performance of the internal circuit 20 is not degraded. If the impedance of the fourth resistive element R4 is lower than the impedance of the internal circuit 20, the surge current applied to the pad 14 hardly flows into the internal circuit 20, but does flow into the fourth resistive element R4. The components of relatively high frequencies in the surge current flow to the ground via the fourth resistive element R4 and the capacitive element C2. The components of low frequencies are applied to the gate of the protection FET 30 via the fourth resistive element R4 and the capacitive element C1 (as indicated by the arrow A in FIG. 8). Accordingly, the protection FET 30 is turned on. The surge current flows from the pad 14 to the ground via the fourth resistive element R4 and the protection FET 30 (as indicated by the arrow B in FIG. 8). The functions of the second resistive element R2 and the capacitive element C1 are the same as those of the first embodiment, and therefore, explanation of them is omitted here.

As described above, in accordance with the fifth embodiment, damage to the internal circuit 20 due to a surge applied to the pad 14 can be prevented, without deterioration of the performance of the internal circuit 20.

To protect the fourth resistive element R4 from damage, the resistance value of the fourth resistive element R4 should preferably be ten times as large as the value of the ON resistance of the protection FET 30. Further, in a case where the resistance value of the fourth resistive element R4 is equal to or smaller than the value of the ON resistance of the protection FET 30, only a potential difference equal to or smaller than that of the protection FET 30 is added to the fourth resistive element R4, even when a surge is input to the pad 14. Accordingly, the possibility that the fourth resistive element R4 is damaged becomes almost zero.

The fourth resistive element R4 may also function as an attenuator. More specifically, a part of a signal that is input from the pad 14 is grounded via the fourth resistive element R4 and the capacitive element C2. As a result, the signal input from the pad 14 is attenuated and is input to the internal circuit 20. Also, a signal that is output from the internal circuit 20 is attenuated and is output to the pad 14. In this manner, the protection circuit 10e can be connected to the grounded side of the fourth resistive element R4 used as an attenuator.

### Sixth Embodiment

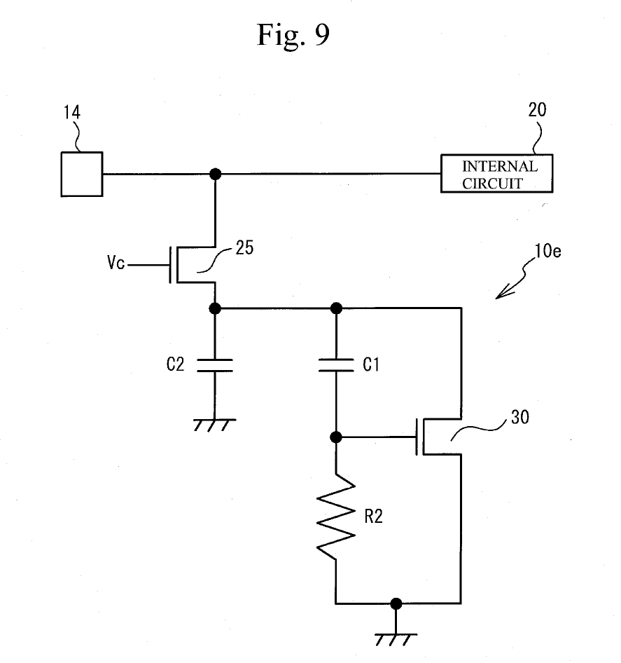

Referring now to FIG. 9, a sixth embodiment of the present invention is described. In the sixth embodiment, the fourth resistive element R4 is replaced with a FET 25. The other aspects of this structure are the same as those of the structure of the fifth embodiment shown in FIG. 8, and therefore, explanation of them is omitted here. As in the sixth embodiment, the fourth resistive element R4 may be replaced with the FET 25. The FET 25 can function as a variable resistance, varying the gate voltage Vc. In this manner, the impedance ratio between the internal circuit 20 and the FET 25 can be varied. Thus, the damping ratio of the attenuator can be arbitrarily set.

In the first through sixth embodiments, the protection FET 30 may be a GaAs-based FET. A GaAs-based FET is a FET that uses a material containing GaAs, such as InGaAs, which is mixed crystals of GaAs and InAs, or AlGaAs, which is mixed crystals of GaAs and AlAs.

It should be noted that, in this specification, the term “connect” is used for either direct or indirect connections, without departing from the scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

The present application is based on Japanese Patent Application No. 2007-089989 filed on Mar. 30, 2007, the entire disclosure of which is hereby incorporated by reference.

What is claimed is:

1. A semiconductor device comprising:
a pad;
an internal circuit;
a protection FET that has a drain connected to the pad, and a source connected to a reference potential;
a first resistive element that is connected between the drain of the protection FET and the internal circuit, and has a larger resistance value than a value of a series resistance between the drain of the protection FET and the pad;
a capacitive element that is connected between the pad and a gate of the protection FET; and
a second resistive element that is connected between the gate of the protection FET and the source of the protection FET.

2. The semiconductor device as claimed in claim 1, wherein the value of the series resistance between the drain of the protection FET and the pad is equal to or smaller than a value ten times as large as a value of an ON resistance of the protection FET.

3. The semiconductor device as claimed in claim 1, wherein the value of the series resistance between the drain of the protection FET and the pad is equal to or smaller than a value of an ON resistance of the protection FET.

4. The semiconductor device as claimed in claim 1, further comprising
a third resistive element that is connected between the capacitive element and the pad.

5. The semiconductor device as claimed in claim 1, wherein the capacitive element is connected between a node between the first resistive element and the pad, and the gate of the protection FET.

6. The semiconductor device as claimed in claim 1, wherein the capacitive element is connected between a node between the first resistive element and the internal circuit, and the gate of the protection FET.

7. A semiconductor device comprising:
a pad;
an internal circuit;
a fourth resistive element that has one end connected to a node between the pad and the internal circuit;
a protection FET that has a drain connected to the other end of the fourth resistive element, and a source connected to a reference potential;
a capacitive element that is connected between the other end of the fourth resistive element and a gate of the protection FET; and
a second resistive element that is connected between the gate of the protection FET and the source of the protection FET.

8. The semiconductor device as claimed in claim 7, wherein a resistance value of the fourth resistive element is equal to or smaller than a value ten times as large as a value of an ON resistance of the protection FET.

9. The semiconductor device as claimed in claim 7, wherein a resistance value of the fourth resistive element is equal to or smaller than a value of an ON resistance of the protection FET.

10. The semiconductor device as claimed in claim 1, wherein the protection FET is a GaAs-based FET.

11. The semiconductor device as claimed in claim 1, wherein the protection FET is an enhancement-mode FET.

12. The semiconductor device as claimed in claim 1, wherein the internal circuit is a radio frequency circuit.
